(19) United States
(12) Patent Application Publication
(10) Pub. No.: US 2004/0179733 A1
(43) Pub. Date: Sep. 16, 2004

(54) Image reading apparatus

(75) Inventor: Nobuyuki Okubo, Kanazawa-shi (JP)

Correspondence Address: STAAS & HALSEY LLP, SUITE 700, 1201 NEW YORK AVENUE, N.W., WASHINGTON, DC, 20005, US

(73) Assignee: PFU Limited, Ishikawa (JP)

(21) Appl. No.: 10/791,796

(22) Filed: Mar. 4, 2004

(30) Foreign Application Priority Data
Mar. 11, 2003 (JP) 2003-065467

(51) Int. Cl. G06K 9/34; G06K 9/18

(52) U.S. Cl. 382/180; 382/289; 382/182

(57) ABSTRACT

Labeling process unit groups a continuous black pixel area as a group by determining the sequence of black pixels from the binary image data read from the image input device, and extracts bounding rectangle information about each of the grouped continuous black pixel areas. Row extracting process unit extracts row rectangle information contained in an original image from the group bounding rectangle information extracted by the labeling process unit. Punctuation mark identification unit identifies a punctuation mark contained in the row rectangle extracted by the row extracting process unit. With the configuration, the direction of a row can be automatically determined by checking the relative position of the punctuation mark in a row based on the extracted row rectangle information and the extracted bounding rectangle information.

### BACKGROUND OF THE INVENTION

1. Field of the Invention

This invention relates to an image reading apparatus, and more particularly to an image reading apparatus to read an image which contains character information and to output the image correctly by turning the image based on the automatically determination of a direction of an original, without setting the direction of the original by user.

2. Description of the Related Art

When a document image containing character information is read, an original to be read may contain characters in different directions. In that case, a user manually sets the direction of each original and then reads an image according to the setting information. Thus, when there are a lot of originals, the manual setting process should be performed for each original in such image reading apparatus, so that a long time is needed and it is troublesome for the user to operate such apparatus.

To solve the above-mentioned problem, an OCR (optical character reader) function is implemented on the image reading apparatus so that a character written in a document can be recognized and the direction of the original can be correctly determined (for example, patent document #1; Japanese Utility Model Application Laid-Open No. 5-12960).

The function is realized by performing the process as shown in FIG. 10. A character image written in an original is read as image data by an image input device 50, and turned by an image data turning process unit 51 by 0°, 90°, 180°, and 270° to create the four turned image data. Each of the four turned characters is recognized by a character recognition process unit 52 performing a pattern matching process with the character data stored in a recognition dictionary 53. And, a probability of correct determination is obtained. The probability indicates the probability of correct recognition of each of the turned images. Thus, a direction determination unit 54 receives the information about the correct determination probability of the obtained character recognition, and determines the direction of the highest probability of correct determination as the direction of the original.

In addition, to prevent a wrong determination, the above-mentioned process is performed on each of a plurality of characters written in an original, and a process of selecting the direction having a higher probability of the direction of an original is also performed.

However, the determination of the direction of an original using the above-mentioned OCR character recognition technology has problems as follows. That is, the image reading apparatus should be implemented with the OCR function. And, a language is to be manually set before determining the direction, because a dedicated OCR engine is required for each language which is used for writing in the original. Further, it can not be possible to process an original which contain a plurality of languages.

As described above, it is necessary to frequently perform the character recognizing process for determination of the direction of an original, so that the speed of reading an image is slow.

Furthermore, since the determination of the direction of an original is performed at each time when an image is read, it is necessary to perform the process within the shortest possible time. Therefore, it is preferable to realize the function using hardware. However, it is very difficult to realize the OCR function using hardware, and it is almost impossible to incorporate the OCR function using hardware and having a capability to process a plurality of languages into the image reading apparatus.

As described above, the conventional technology has the following problems. That is, when an image reading apparatus reads an image which contains character information, and when the direction of each original to be read is different, a user should manually set the direction each time an original is read, so that it is very inconvenient for the user to operate such apparatus.

To solve the problem, as aforementioned, an image reading apparatus which is implemented with an OCR function for recognizing a character has been developed to realize an apparatus for automatically determining the direction with the highest probability of correct recognition as the direction of the original.

However, in this method, it is necessary to implement the OCR function on the image reading apparatus. This invites the following problems. That is, the apparatus becomes costly. It takes a long time to recognize a character by the OCR. The OCR process cannot be realized by hardware to perform the process within a short time. And, an original which contains a plurality of languages cannot be practically processed.

### SUMMARY OF THE INVENTION

It is an object of the present invention to provide an image reading apparatus to automatically determine direction of an image on an original without using a complicated and expensive character recognition function such as an OCR, when the image which contains character information is read by the image reading apparatus for reading the image of the original as electronic data.

To solve the above-mentioned problems, an image reading apparatus of the present invention includes labeling process unit, row extracting process unit, punctuation mark identification unit and row direction determination unit. The labeling process unit performs a “labeling” process by using the binarization unit, extracting a continuous black pixel area by determining a sequence of black pixels from the image data obtained by converting the image data into monochrome image data, performing a grouping process, and extracting group bounding rectangle information about grouped continuous black pixel areas. The row extracting process unit extracts row rectangle information from the position relationship of the group bounding rectangle of the grouped continuous black pixel areas obtained by the above-mentioned labeling process unit. The punctuation mark identification unit identifies a continuous black pixel area predicted as a punctuation mark, a period, or a comma contained in a row rectangle according to the row rectangle information extracted by the row extracting process unit, and the group bounding rectangle information about the grouped continuous black pixel areas. The row direction determination unit determines the direction of a row based on the characteristic of the relative position between the row rectangle information extracted by the row extracting process unit and the continuous black pixel area analogized as a punctuation mark, a period, or a comma identified by the punctuation mark identification unit.

Preferably the image reading apparatus further includes binarizing process unit which binarizes multi-valued image data when image data of a multi-valued image is read by an image input device, when the image data read by the image input device is multi-valued data.

Preferably the image reading apparatus further includes statistical determination process unit which determines the direction determined as the direction of a row in the most rows as the direction of the original in the statistical process by performing the above-mentioned row direction determining process on a plurality of rows contained in the original.

### BRIEF DESCRIPTION OF THE DRAWINGS

FIG. 1 shows the entire configuration of the present invention.

FIGS. 2A and 2B are an explanatory view of the labeling process.

FIG. 3 is an explanatory view of the case in which a group bounding rectangle is linearly arranged in the X direction.

FIG. 4 is an explanatory view of the case in which a group bounding rectangle is linearly arranged in the Y direction.

FIG. 5 is an explanatory view of the punctuation mark identifying process.

FIGS. 6A and 6B are an explanatory view of the case in which characters are written in a horizontal row.

FIGS. 7A and 7B are an explanatory view of the case in which characters are written in a vertical row.

FIG. 8 is an explanatory view of the row direction determining process.

FIGS. 9A and 9B are an explanatory view of the process performed when a row rectangle contains a plurality of punctuation marks.

FIG. 10 is an explanatory view of the conventional process of automatically determining the direction of an original.

### DETAILED DESCRIPTION OF THE PREFERRED EMBODIMENT

The present invention is embodied as follows. The image reading apparatus of the present invention has a binarizing process unit to binarize the data which binarizes multi-valued image data when the image data read by the image input device such as a CCD, etc. is multi-valued image data. Thus, when read image data is multi-valued data, an image reading apparatus for reading a color or multilevel gray scale image converts the read data into a binary monochrome image, thereby simplifying the subsequent image processing.

The image reading apparatus has a labeling process unit which extracts groups continuous areas by determining a sequence of black pixels in the binarized black and white image data, and extracts grouped bounding rectangle information about a grouped continuous black pixel area. Thus, contour information about a character component such as a dot, a line, etc. can be obtained. The contour information is the basic information in determining the direction of a character written in an original image.

The image reading apparatus has a row extracting process unit which extracts row rectangle information about a character written in an original according to the position information about a group bounding rectangle extracted by the labeling process unit. As a result, when the direction of a row is determined, contour data of a row rectangle which is the basic information in obtaining the relative position to the continuous black pixel area analogized as a punctuation mark, a period, or a comma can be obtained.

The image reading apparatus has a punctuation mark identification unit which identifies a group bounding rectangle analogized as a punctuation mark, a period, or a comma from a continuous black pixel area group extracted in a labeling process in the row rectangle information extracted by the above-mentioned unit.

The image reading apparatus has a row direction determination unit which obtains the relative position between rectangles from the position information about the group bounding rectangle of a continuous black pixel area analogized as a punctuation mark, a period, or a comma by the punctuation mark identification unit and the row rectangle information containing it, and determines the direction of a row from the feature of the position. Thus, since the direction of an original can be easily determined from the direction of a row without recognizing a character using the OCR function, a high-speed and inexpensive process can be performed by hardware, and an original containing descriptions written in a plurality of languages can also be processed.

The image reading apparatus has a statistical determination process unit performs the row direction determining process by the row direction determination unit on a plurality of rows contained in a original, and determines the direction determined as the direction of a row in the most rows as the direction of an original in the statistical process. Thus, although a wrong determination is made depending on the contents of data in a row, a plurality of rows is determined and the direction of the highest probability of correct direction of rows can be determined as the direction of an original, thereby finally preventing the occurrence of wrong determination in the direction of an original.

Described below are the typical embodiments of the present invention. In the following explanation, the same component is assigned the same reference numeral, and the detailed explanation can be omitted for suppression of overlapping descriptions.

The apparatus according to the present invention is an image reading apparatus which can read an image data that contain character information and can automatically determine the direction of an original based on the read image data.

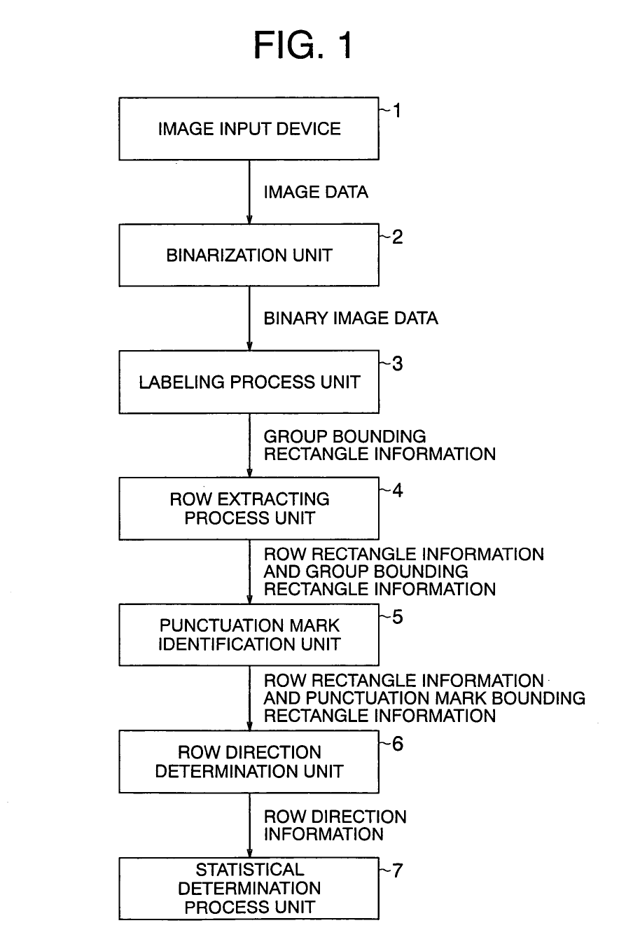

As shown in FIG. 1, the image reading apparatus has an image input device 1 such as a CCD, etc., and reads an image of an original as electronic data. The image input device 1 may read or input a color or multilevel gray scale image. In this case, the read image data is represented by multivalues (8 bits, 24 bits, etc.) for information per pixel.

A binarization unit 2 converts the input data into binary data of two levels of black and white. The binarizing process is performed by a method in which the brightness of a pixel represented by multi-values is defined as 1 when it is equal to or larger than a predetermined threshold, and as 0 when it is smaller than the threshold. The image data converted into a binary monochrome image by the binarization unit 2 is transmitted to a labeling process unit 3 for a labeling process of grouping a continuous black pixel area.

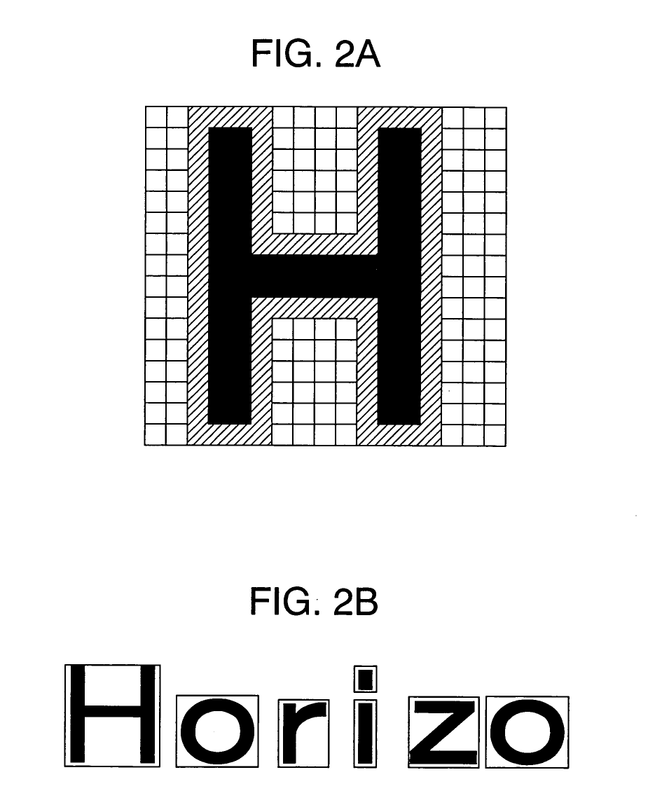

The labeling process is as follows. First, as shown in FIG. 2A, a sequence of black pixels is determined and grouped the continuous black pixel area as one unit, as indicated by a range enclosed by the diagonal lines in FIG. 2A. Then, as shown in FIG. 2B, group bounding rectangle in a continuous black pixel area is extracted for each group to obtain group bounding rectangle information for each grouped continuous black pixel area.

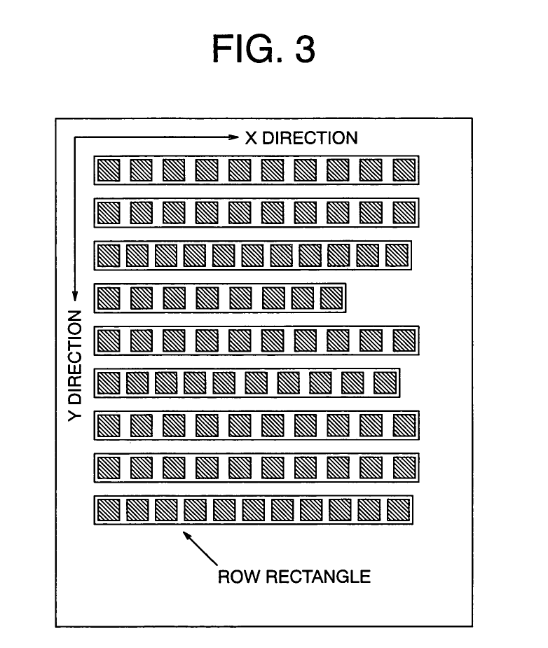

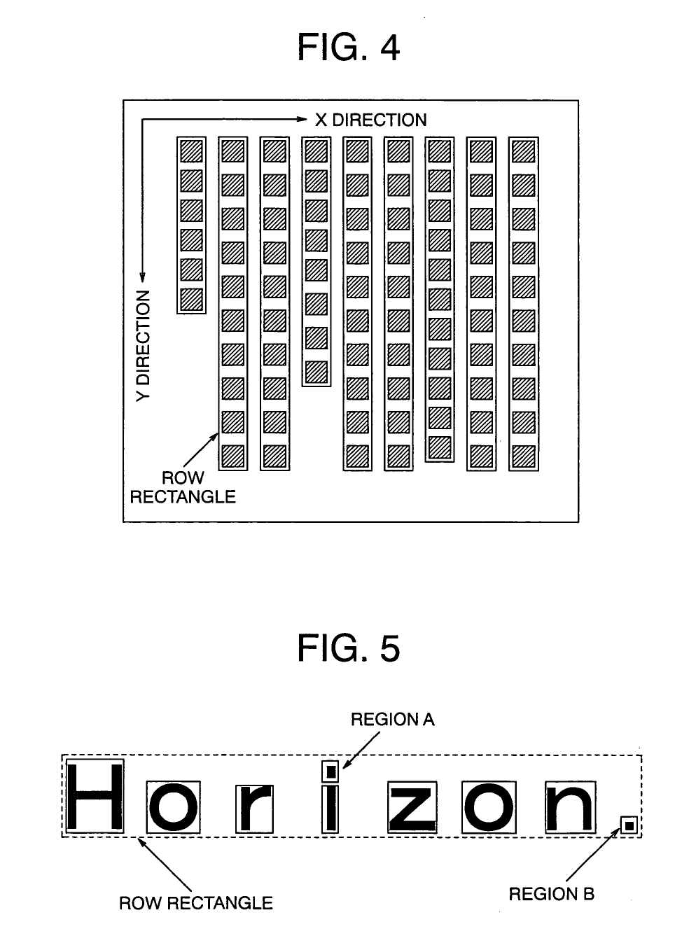

According to the position information about the group bounding rectangle obtained in the labeling process, as shown in FIG. 3, it is determined whether characters are arranged in a line in the X direction as shown in FIG. 3, or in a line in the Y direction as shown in FIG. 4, and extracts row rectangle information by a row extracting process unit 4 by setting a group of group bounding rectangles arranged in a line as a row.

Punctuation mark identification unit 5 analogizes and identifies a square area which is much smaller than other group bounding rectangles and is a group bounding rectangle independent of other group bounding rectangles as shown in FIG. 5 as a punctuation mark, a period, or a comma among group bounding rectangles of a continuous black pixel area contained in the extracted row rectangle. In FIG. 5, the region A is not isolated with group bounding rectangle existing immediately below, but on the contrary the region B is a small isolated square area.

The punctuation mark identification unit 5 obtains a relative position of the punctuation mark, the period, or the comma in a row, based on the position information about a row rectangle and the position information about the group bounding rectangle of a continuous black pixel area analogized as a punctuation mark, a period, or a comma, thereby determines the direction of an original as follows.

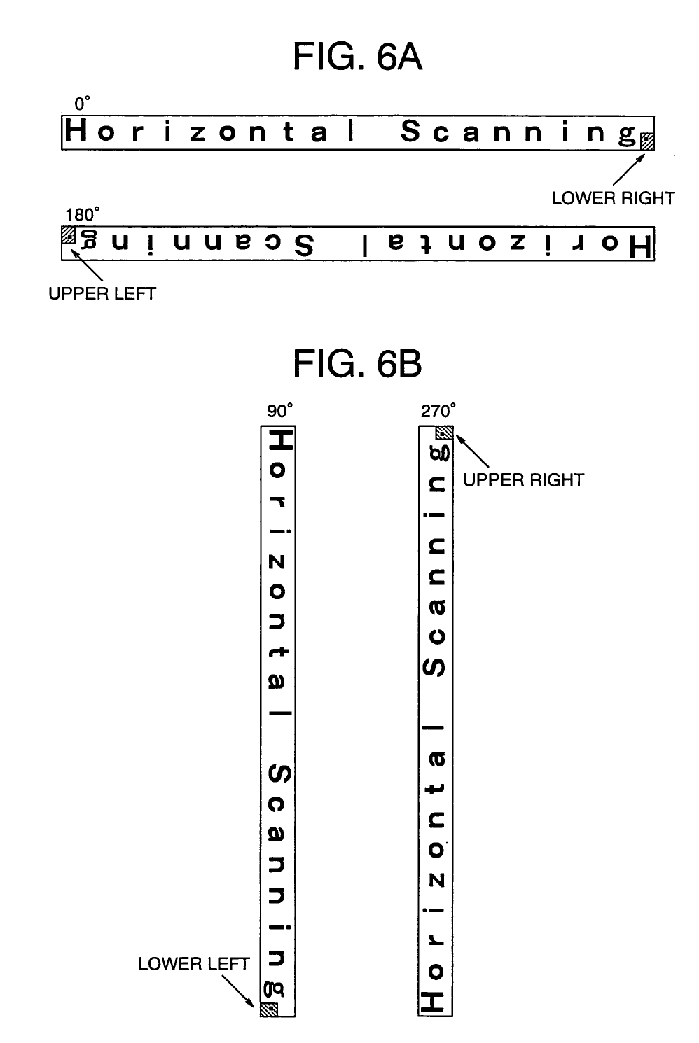

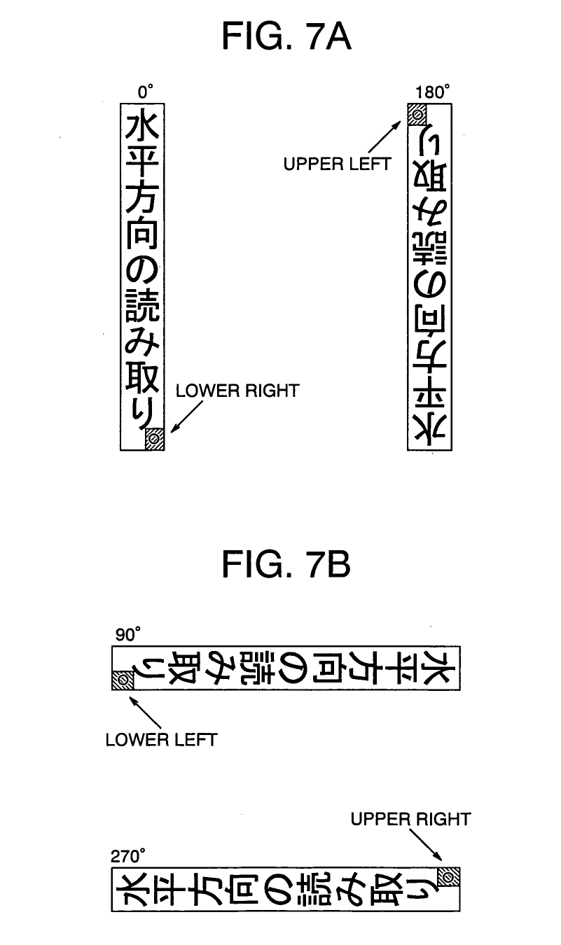

When a row rectangle is a rectangle having longer sides in the X direction, and when the characters (English characters) written in an original are written in a horizontal row, the position of a punctuation mark is lower right or upper left as shown in FIG. 6A. However, when the character (Japanese characters) written in an original are written in a vertical row, the position of a punctuation mark is upper right or lower left as shown in FIG. 7B. FIGS. 7A and 7B show image examples of vertical writing in Japanese.

When a row rectangle is a rectangle having longer sides in the Y direction, and when the characters (English characters) written in an original are written in a horizontal row, the position of a punctuation mark is upper right or lower left as shown in FIG. 6B. However, when the character (Japanese characters) written in an original are written in a vertical row, the position of a punctuation mark is upper left or lower right as shown in FIG. 7A.

Thus, based on the information about the aspect ratio of a row rectangle and the relative position of a punctuation mark, it is determined whether the characters are written horizontally or vertically, and direction of the row can be determined.

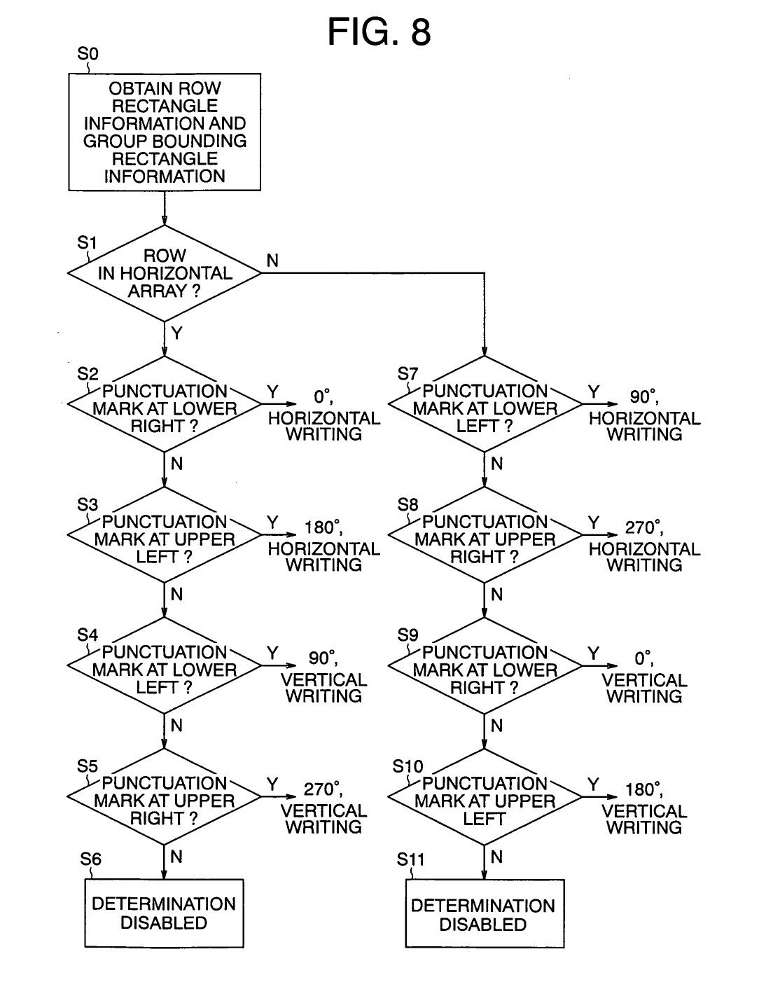

Practically, according to the flowchart shown in FIG. 8, the vertical array of characters, the horizontal array of characters, and the direction of an original can be determined.

A row direction determination unit 6 obtains the row rectangle information and the information about the group bounding rectangle identified as a punctuation mark in step S0, and determines whether or not the row is a horizontal array or a vertical array based on the aspect ratio of the row rectangle in step S1.

When the row is a horizontal array as a result of the determination, then the process is proceeded to step S2. When the row is vertical array, the process is proceeded to step S7.

When the row is a horizontal array, the relative position between the row rectangle and the group bounding rectangle identified as a punctuation mark is obtained in step S2. When the relative position is lower right, then it is determined that the row is a horizontal writing array as shown in FIG. 6A, and the direction is 0°.

In step S3, the relative position between the row rectangle and the group bounding rectangle identified as a punctuation mark is obtained. When the relative position is upper left, then it is determined that the row is a horizontal writing array as shown in FIG. 6A, and the direction is 180°.

In step S4, the relative position between the row rectangle and the group bounding rectangle identified as a punctuation mark is obtained. When the relative position is lower left, then it is determined that the row is a vertical writing array as shown in FIG. 7B, and the direction is 90°.

In step S5, when the row is a horizontal array, the relative position between the row rectangle and the group bounding rectangle identified as a punctuation mark is obtained. When the relative position is upper right, then it is determined that the row is a vertical writing array as shown in FIG. 7B, and the direction is 270°.

In step S6, when the above-mentioned cases do not hold, it is determined that the direction of the row cannot be determined.

When it is determined in step Si that the row is a vertical array, the process is proceeded to step S7, the relative position between the row rectangle and the group bounding rectangle identified by a punctuation mark contained therein is obtained, it is determined whether the row is a horizontal writing array or a vertical writing array, and the direction of the row is determined, as shown in steps S7 to S11, which are similar with the steps S2 to S6.

As described above, although the direction of a row is automatically determined, a wrong determination can be made depending on the contents of the character data in the row. Therefore, the statistical determination process unit to perform the determining process on a plurality of row rectangles in the original page, and determining in the statistical process the direction determined as the direction of the row in the most rows as a final direction of the original.

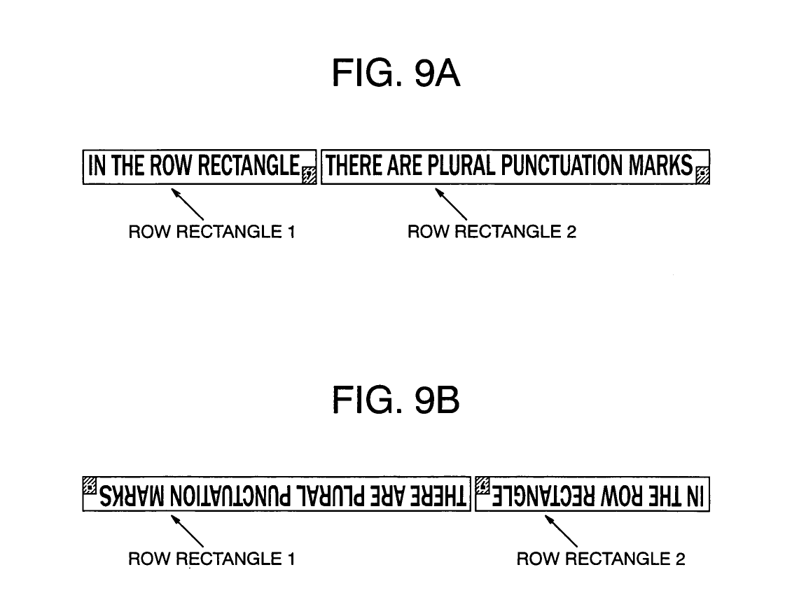

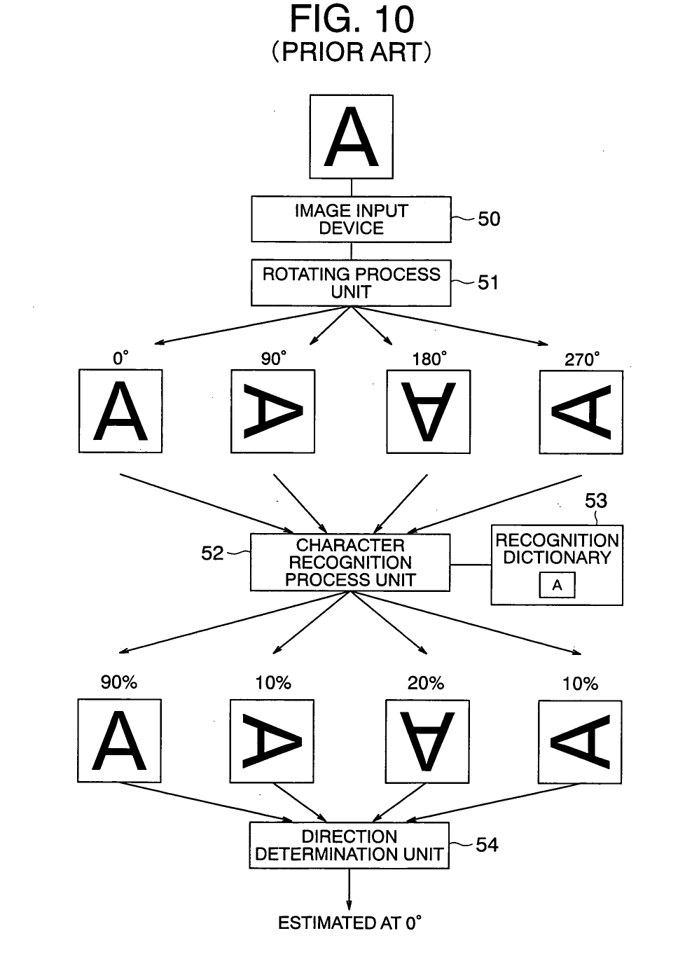

When there is a plurality of group bounding rectangles identified as punctuation marks in a row rectangle, the group bounding rectangles are processed as follow. First, as shown in FIG. 9A, when there is no group bounding rectangle identified as a punctuation mark at the start of the row rectangle, it is determined that the end of the group bounding rectangle identified as a punctuation mark indicates the end of a row rectangle and the row rectangle is divided into a plurality of row rectangles. And, as shown in FIG. 9B, when there is a group bounding rectangle identified as a punctuation mark at the start of the row rectangle, it is determined that the rectangle continues immediately before the group bounding rectangle identified as the next punctuation mark, and the row rectangle is divided into a plurality of row rectangles. The direction determining process can be performed on each of the divided row rectangles, and the direction of the row can be determined in a statistical process, or the direction determining process can be performed using, among punctuation marks and recognized group bounding rectangles, a group bounding rectangle with the highest probability of punctuation mark.

Unit to turn read image data in a predetermined direction when the direction of image data to be read is predetermined by automatically determining the direction of an original so that the image data of the entire original can be read in the same direction.

The present invention can obtain the following effect.

Conventionally, when an image reading apparatus reads an image containing character information, and there is an original containing descriptions written in different directions, the settings of the directions are manually changed by a user, which is a very inconvenient operation. To solve the problem, an image reading apparatus capable of automatically determining the direction of the highest probability of correct recognition as the direction of an original by loading an OCR function and performing a character recognizing process has been proposed. However, with the apparatus, it is necessary to load an OCR function, and the apparatus is costly. Furthermore, the character recognizing process has to be repeatedly performed for all directions, thereby requiring a long processing time and lowering the speed of reading images. To enhance the reading speed, the preprocess can be effectively performed as hardware. However, it has been very difficult to realize the OCR function as hardware. Furthermore, to recognize a character by the OCR function, it is necessary to set the language of the characters contained in the original, but it is difficult to recognize an original containing descriptions written in a plurality of languages.

According to the present invention, an image containing character information can be read without a character recognizing process using, for example, an OCR, etc. with the direction of the original containing descriptions written in a plurality of languages automatically determined.

Furthermore, since the system is very simple, it can be realized as hardware to speed up the entire process.

What is claimed is:

1. An image reading apparatus for reading an image which contains character information, the apparatus comprising:
labeling process unit to group a continuous black pixel area forming characters contained in a read two levels of black and white monochrome image of two levels, and extracting group bounding rectangle information about a grouped continuous black pixel area;
row extracting process unit to extract row rectangle information from position information about a group bounding rectangle of the continuous black pixel area extracted and grouped by the labeling process unit;
punctuation mark identification unit to identify a punctuation mark, a period, or a comma from a position and a size of the continuous black pixel area grouped by the labeling process unit; and
row direction determination unit to determine a direction of a row from a position relationship among a punctuation mark, a period, or a comma in a row rectangle of characters contained in an image.

2. The image reading apparatus according to claim 1, further comprising:
binarizing process unit to binarize multi-valued image data when image data of a multi-valued image is read by an image input device.

3. The image reading apparatus according to claim 2, further comprising:
statistical determination process unit to determine a direction of a row by the row direction determination unit for a plurality of rows, and determining a direction having a higher probability of a direction of a row as a direction of an original in a statistical process.

4. The image reading apparatus according to claim 1, further comprising:
statistical determination process unit to determine a direction of a row by the row direction determination unit for a plurality of rows, and determining a direction having a higher probability of a direction of a row as a direction of an original in a statistical process.
